(19) United States
(12) Patent Application Publication
(10) Pub. No.: US 2025/0388261 A1
(43) Pub. Date: Dec. 25, 2025

(54) Method for Operating a Steering System

(71) Applicant: Robert Bosch GmbH, Stuttgart (DE)

(72) Inventor: Tobias Buchmann, Schwaebisch Gmuend (DE)

(21) Appl. No.: 19/245,603

(22) Filed: Jun. 23, 2025

(30) Foreign Application Priority Data
Jun. 25, 2024 (DE) 10 2024 205 875.0

(51) Int. Cl. B62D 6/00

(52) U.S. Cl. CPC B62D 6/008

(57) ABSTRACT

A method is for operating a steering system in a vehicle. The vehicle is configured to operate at different levels of automation. The steering system includes a steering handle by which a driver of the vehicle acts on the steering and which provides steering feel as feedback to the driver using a feedback unit. A signal is generated upon a transition from a higher level of automation to a lower level of automation. The signal influences the steering feel provided to the driver from the feedback unit during a handover period.

This application claims priority under 35 U.S.C. § 119 to patent application no. DE 10 2024 205 875.0, filed on Jun. 25, 2024 in Germany, the disclosure of which is incorporated herein by reference in its entirety.

The disclosure relates to a method for operating a steering system and an assembly for carrying out the method.

### BACKGROUND

A steering system is used in a vehicle to influence the direction of travel of the vehicle. For this purpose, the steering system typically has a steering handle, for example a steering wheel, with which the driver can intervene in the steering system and which can provide the driver with a steering feel, so that they can draw conclusions about the driving situation.

A steer-by-wire steering system provides that a steering command is only electrically transmitted from a sensor to an electromechanical actuator that executes the steering command, via one or more control devices. Such a steering system regularly comprises a feedback unit, e.g. a steering wheel actuator, a steering actuator, for example in the form of a rack actuator, and a unit for evaluating and calculating signals that are implemented, for example, in software or in software functions.

The method presented is particularly used in a vehicle that can achieve different levels of automation, for example, as defined in SAE International J3016.

Vehicles typically distinguish between assisted, automated, and autonomous driving. The degree of automation is determined by the extent of automation or the level of automation. These levels are:
Level 0 self-driver, the driver is driving himself,
Level 1 assisted mode, certain assistance systems help with vehicle operation, e.g. a distance-regulated cruise control,
Level 2 assisted mode, use of semi-automated functions, such as automatic parking, staying the lane,
Level 3 automated mode, the driver does not have to constantly monitor the system, the vehicle independently performs functions, e.g. lane change and staying in the lane,
level 4 autonomous mode, high automation, the guidance of the vehicle is permanently taken over by the system,
Level 5 autonomous mode, full automation, no driver required.

In (partially) automated driving functions where the driver does not perform steering motion or has their hands off of the steering wheel for extended periods of time, their feel for the handling of the vehicle decreases over time. This means that when the driver leaves the (partially) automated driving state, they must first get used to the steering system again. This process may be perceived as inconvenient, i.e., particularly uncomfortable for the driver or, in the worst case scenario, may even increase the risk of an accident. This may be caused, for example, by inadvertently strong or weak steering motions.

For steering interventions that occur during (partially) automated driving, cooperative driving functions are known. In these functions, the driver steering movement and the movement specified by the assistance system are combined to a resultant steering result.

### SUMMARY

The presented method is used to operate a steering system in a vehicle. The vehicle is configured to operate at different levels of automation, as described above by way of example. The steering system has a steering handling, via which the driver may act on the steering system and which may provide a steering feel as feedback to the driver via a feedback unit. When transitioning from a higher level of automation to a lower level of automation, a signal is generated that influences the steering feel provided to the driver during a transition period.

The signal, which is typically transmitted to the feedback unit, thus influences the steering feel during the handover period.

The method is used in a configuration for operating a steer-by-wire steering system which, as a feedback unit, comprises a feedback actuator as well as a steering actuator, wherein the signal is transmitted to the feedback actuator to influence the steering feel. For example, a steering wheel actuator serves as the feedback actuator. The steering actuator is provided, for example, by a rack actuator.

It is thus envisaged in the configuration to temporarily adjust the steering feel when returning the responsibility for driving responsibility from an automated system to the driver. In particular, the following may occur (i) the steering support may be adjusted to be more indirect, (ii) the centering may be amplified or, alternatively, the vehicle may be centered on the lane, and (iii) the steering support may be increased, wherein the extent of the respective adjustment can be increased as a function of the time period that has elapsed without a manual steering intervention. A linear or a non-linear dependence may be selected, and a cap may prove to be useful in this case.

The duration of the temporary adjustment, which corresponds to the so-called acclimatization time, may also be differentiated depending on the duration of driver inactivity, wherein it appears advantageous to select a longer acclimatization time with respect the regular steering profile following longer periods of driver inactivity.

When returning control to the driver, different handover scenarios may be handled differently. First, regulated handover characterized in that (i) the driver requests the takeover, e.g. by pressing a button or using a menu command, and (ii) the automated system requires a controlled handover within a specified period of time. Second, emergency takeover by the driver, which is characterized in that a sudden, strong steering intervention is performed by the driver, in particular depending on the SAE level. This type of takeover may not be provided or may be prevented by liability law regulations. Third, short term take-over/cooperative driving behaviors

Furthermore, it must be taken into account that the adjustment of the steering profile may generally be carried out in all three scenarios, depending on the length of inactivity. The regulated handover is the most pronounced form available for selection. Since this is not carried out under time pressure and is not only temporary, it is a way to introduce the driver to self-driving again in a comfortable and safe way over a longer period of time, typically several seconds to several minutes. Fading functions can be used for this purpose.

In particular, fading functions are proposed depending on the distance traveled, time traveled and/or number of steering operations.

The handover can occur, for example, as a function of actual steering movements, a non-linear transition, a differentiated consideration of different steering angle ranges, etc. The temporary steering feel may be realized either via a dedicated transitional steering profile or via the variation of individual parameters around a base value.

The extent to which the steering feel is influenced may be reduced gradually, in particular, depending on at least one driving characteristic, and typically may be returned to the original steering feel.

By the method presented, comfort and safety while returning an automated driving function to the driver may be increased. This facilitates re-acclimatization to a state where the driver is driving themselves once again.

The method presented is characterized, in particular in several of the embodiments, by the following:

The introduction and configuration of a handover steering feel when returning steering from an automated driving function to the driver.

The strength and extent of the transitional steering feel will vary depending on the length of driver inactivity preceding this.

The transitional steering feel is returned to the actual steering feel over a longer period of time or through the actual steering movements carried out.

The method presented may in principle be used for all vehicles with (partially) automated driving functions. Restrictions may exist for vehicles having a conventional electric power steering system. The method may be employed in full in a steer-by-wire steering system.

The assembly described comprises an evaluation unit that is configured to perform the presented method. The assembly or the evaluation unit can be implemented in hardware and/or software and can be implemented, for example, in a control unit of the vehicle or configured as such.

Further advantages and embodiments of the disclosure are shown in the description and the accompanying drawings.

It is understood that the abovementioned features and those to be explained below can be used not only in the combination indicated in each case, but also in other combinations or on their own, without departing from the scope of the disclosure.

### BRIEF DESCRIPTION OF THE DRAWINGS

FIG. 1 shows a flow chart of a possible sequence of the presented method; and

FIG. 2 shows a schematic, highly simplified representation of a vehicle with an embodiment of the described arrangement for carrying out the presented method.

### DETAILED DESCRIPTION

The disclosure is illustrated schematically by means of embodiments in the drawings and is described in detail below with reference to the drawings.

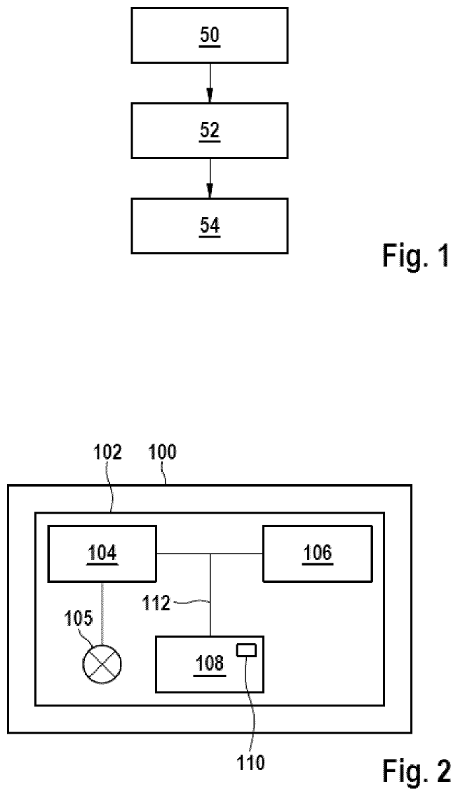

FIG. 1 shows a flow chart of a possible sequence of the presented method. In a first step 50, travel of a vehicle having a steer-by-wire steering system and having the ability to operate at different levels of automation begins. Travel begins at a level of L3 or higher. At a later time, in a step 52, the vehicle will achieve level L0. Then, in a step 54, the driver's steering feel on the steering handle is influenced for a certain period of time, e.g. conveyed via a feedback actuator. The strength and/or duration of this influence may be based on the duration of operation in level 3 prior to the transition.

FIG. 2 shows a schematic representation of a vehicle, which is denoted overall by reference number 100. This vehicle 100 has a steer-by-wire steering system 102 with a feedback actuator 104 associated with a steering handle 105 and a steering actuator 106, as well as an assembly 108 in which an evaluation unit 110 is provided for performing the method presented. This assembly 108 or the evaluation unit 110 is implemented by, for example, software functions.

Furthermore, the vehicle 100 is configured to achieve different levels of automation. The assembly 108 can now affect the steering feel imparted to the driver at the steering handle 105 if transitioning from a higher level of automation to a lower level of automation. For example, the feedback actuator 104, which receives a corresponding signal 112 from the assembly 108, may be used for this purpose.

What is claimed is:

1. A method for operating a steering system in a vehicle, comprising:
operating the vehicle at different levels of automation;
providing a steering feel as feedback to a driver of the vehicle through a steering handle of the steering system using a feedback unit of the steering system; and
generating a signal during a transition period when the vehicle transitions from a higher level of automation to a lower level of automation, the signal configured to cause the feedback unit to influence the steering feel.

2. The method according to claim 1, wherein:
the steering system is a steer-by-wire steering system,
the feedback unit includes a steering actuator and a feedback actuator, and
the signal is transmitted to the feedback actuator to influence the steering feel.

3. The method according to claim 1, wherein during the transition period the vehicle transitions from an automated operation to a non-automated operation.

4. The method according to claim 1, wherein the influence on the steering feel is determined as a function of at least one variable that characterizes operation at the higher level of automation prior to the transition period.

5. The method according to claim 4, wherein the influence on the steering feel is determined by a duration of operation at the higher level of automation prior to the transition period as the at least one variable.

6. The method according to claim 4, wherein a duration and/or a strength of the influence on the steering feel is determined by the at least one variable.

7. The method according to claim 1, wherein a degree of influence on the steering feel is gradually reduced as a function of at least one driving characteristic and is returned to an original steering feel after the transition period.

8. The method according to claim 1, wherein the influence on the steering feel comprises at least one of (i) adjusting a steering ratio, (ii) increasing a centering, (iii) centering the vehicle in a travel lane, and (iv) increasing a steering support.

9. The method according to claim 1, wherein different handover scenarios are handled differently.

10. An assembly for operating a steering system in a vehicle, comprising:
a controller configured to carry out the method according to claim 1.

11. The assembly according to claim 10, wherein the controller is configured to operate a steer-by-wire steering system.
